(19) United States
(12) Patent Application Publication
(10) Pub. No.: US 2025/0232246 A1
(43) Pub. Date: Jul. 17, 2025

(54) GEN AI-BASED SYSTEM AND METHOD FOR ITERATIVE REFINEMENT OF INNOVATION DATA USING QUALITY SCORE

(71) Applicant: Cognizant Technology Solutions India Pvt. Ltd., Chennai (IN)

(72) Inventors: Alexis Samuel, Chennai (IN); Pandiyan Adiyapatham, Chennai (IN); Balamurugan Padmanaban, Chennai (IN); Rengaraj Hariram, Chennai (IN); Sajal Garg, Chennai (IN); Ananthi E, Chennai (IN); Elilanban Neehivanan, Chennai (IN); Suma Ullanat Varikkassery, Chennai (IN); Joseph Puthen Purackal Kunjappan, Chennai (IN); Dhivya Prabha Rajkumar, Chennai (IN); Pooja Bajaj, Chennai (IN); Sri Ranjani Kannan, Chennai (IN); Divya Manne, Chennai (IN)

(21) Appl. No.: 19/020,387

(22) Filed: Jan. 14, 2025

(30) Foreign Application Priority Data
Jan. 15, 2024 (IN) 202441002887

(51) Int. Cl. G06Q 10/0639; G06F 8/30; G06Q 30/0282

(52) U.S. Cl. CPC G06Q 10/06395; G06F 8/30; G06Q 30/0282

(57) ABSTRACT

A system and method for iterative refinement of innovation data is provided. The system fetches input data and innovation data to validate input data and innovation data to generate validated data. Innovation data represents data related to an innovation process of a project development lifecycle. Quality score is determined for validated data based on weighted score of one or more predefined parameters. Prompt data is generated from validated data using NLP model and the prompt data is enhanced based on quality score employing enhancement rules to generate enhanced prompt data. An enhanced quality score is assigned to enhanced prompt data to generate a modified prompt data. Features representative of refined innovation data are generated for generating code for deployment based on modified prompt data.

### FIELD OF THE INVENTION

The present invention relates generally to the field of processing of innovation related data in project development lifecycles, and more particularly, the present invention relates to a generative artificial intelligence-based system and method for iterative refinement of innovation data based on quality score.

### BACKGROUND OF THE INVENTION

In the rapidly evolving landscape of technology, innovation stands as a cornerstone in lifecycle of project development processes of enterprises. Enterprises continually strive to enhance their innovation processes, seeking technical advancements in ways to leverage accumulated knowledge and experience. Conventionally, innovation within enterprises involve a multifaceted process, from idea generation and problem-solving to decision-making and project implementation. To this end, accessing historical data and knowledge pertaining to past innovation initiatives is crucial for informed decision-making and avoiding technical challenges. However, traditional methods of accessing and utilizing innovation-related data often prove cumbersome, leading to inefficiencies in decision-making and idea generation.

Typically, enterprises often hold vast amounts of valuable innovation-related data, including employee-generated questions, ideas, and solutions. However, this data often remains untapped due to limitations in traditional search and retrieval methods. Retrieval methods are typically time-consuming, inefficient, and lack the ability to understand nuances of human language and context. Also, existing systems often struggle to identify patterns, trends, and hidden gems within data that makes it difficult for enterprises to gain valuable insights that leads to strategic decision-making and resource allocation during project development lifecycle. Further, collaboration is crucial for effective innovation. However, traditional workflows hinder collaboration by making it difficult for individuals and teams to efficiently share knowledge and refine ideas iteratively.

Further, in a project development lifecycle, challenges in reusing innovative ideas persist due to fragmented repositories, inconsistent documentation, and difficulties in identifying past solutions. Also, a crucial need for maintaining quality and security adds another layer of complexity, as poorly documented or outdated components introduce vulnerabilities. Overcoming these challenges require a strong focus on knowledge management, effective communication, and continuous improvement to unlock true potential of reusability of ideas in project development lifecycles.

Also, conventional methods of managing innovative idea-based information often falls short in providing a seamless and intelligent interface between users and stored data. Traditional approaches to innovation process related data management rely heavily on manual retrieval of data from repositories, which is time-consuming and prone to human error. Furthermore, sheer volume of information, coupled with dynamic nature of innovation, makes it challenging to efficiently extract relevant data insights. Moreover, linguistic nuances in innovation-related queries are not fully addressed, leading to suboptimal results.

Typically, innovative ideas have a long journey from conceptualization to implementation quality whereby of generated ideas vary while combining and merging multiple ideas. Also, multiple ideas in an organisation lead to evaluation overload. As open organisations adopt innovation and crowdsourcing to stay at forefront of innovation, challenges of selecting which ideas to pursue is enormous. Organizations that receive many ideas have difficulty selecting original idea. Also, existing systems lack in terms of rating mechanisms for rating innovative ideas based on customer satisfaction, branding, customer loyalty etc.

In light of the above drawbacks, there is a need for a system and method for enhancing innovation process related data in project development lifecycles of an enterprise. There is a need for a system and method for implementing an intelligent and a streamlined approach to innovation process related data management. Also, there is a need for system and method for generative a artificial intelligence-based implementation of intelligent query refinement and data management. There is a need for a system and a method to bridge gap between users and innovation data, fostering a more efficient, responsive, and ultimately an innovative project development lifecycle.

### SUMMARY OF THE INVENTION

In various embodiments of the present invention, a system 100 for iterative refinement of innovation data is provided. The system 100 comprises a memory 120 storing program instructions and a processor 118 executing program instructions stored in the memory 120. The system 100 is configured to execute an innovation data refinement engine 124 to fetch input data and innovation data to validate the input data and the innovation data to generate a validated data. The innovation data represents data related to an innovation process of a project development lifecycle. The system 100 determines a quality score for the validated data based on a weighted score of one or more predefined parameters and generates a prompt data from the validated data using an NLP model. The system 100 is enhances the prompt data based on the quality score employing enhancement rules to generate an enhanced prompt data. The system 100 assigns an enhanced quality score to the enhanced prompt data to generate a modified prompt data. The system 100 generates features representative of refined innovation data for generating a code for deployment based on the modified prompt data.

In various embodiment of the present invention, a method for iterative refinement of innovation data is provided. The method comprises fetching input data and innovation data to validate the input data and the innovation data to generate a validated data. The innovation data represents data related to an innovation process of a project development lifecycle. The method comprises determining a quality score for the validated data based on a weighted score of one or more predefined parameters. The method comprises generating a prompt data from the validated data using an NLP model and enhancing the prompt data based on the quality score by employing enhancement rules to generate an enhanced prompt data. The method comprises assigning an enhanced quality score to the enhanced prompt data to generate a modified prompt data and generating features representative of refined innovation data for generating a code for deployment based on the modified prompt data.

In various embodiment of the present invention, a computer program product is provided. The computer program product comprises a non-transitory computer-readable medium having computer-readable program code stored thereon. The computer-readable program code comprises instructions that, when executed by a processor, cause the processor to fetch input data and innovation data to validate the input data and the innovation data to generate a validated data. The innovation data represents data related to an innovation process of a project development lifecycle. A quality score is determined for the validated data based on a weighted score of one or more predefined parameters and a prompt data is generated from the validated data using employing an NLP model. The prompt data is enhanced based on the quality score employing enhancement rules to generate an enhanced prompt data. An enhanced quality score is assigned to the enhanced prompt data to generate a modified prompt data and features representative of refined innovation data are generated for generating a code for deployment based on the modified prompt data.

### BRIEF DESCRIPTION OF THE ACCOMPANYING DRAWINGS

The present invention is described by way of embodiments illustrated in the accompanying drawings wherein:

FIG. 1 is a block diagram of a system for iterative refinement of innovation data using quality score, in accordance with an embodiment of the present invention;

FIG. 2 illustrates a flowchart for iterative refinement of innovation data using quality score; and

FIG. 3 illustrates an exemplary computer system in which various embodiments of the present invention may be implemented.

### DETAILED DESCRIPTION OF THE INVENTION

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the scope of the invention. The terminology and phraseology used herein is for the purpose of describing exemplary embodiments and should not be considered limiting. Thus, the present invention is to be accorded the widest scope encompassing numerous alternatives, modifications and equivalents consistent with the principles and features disclosed herein. For purposes of clarity, details relating to technical material that is known in the technical fields related to the invention have been briefly described or omitted so as not to unnecessarily obscure the present invention.

The present invention would now be discussed in context of embodiments as illustrated in the accompanying drawings.

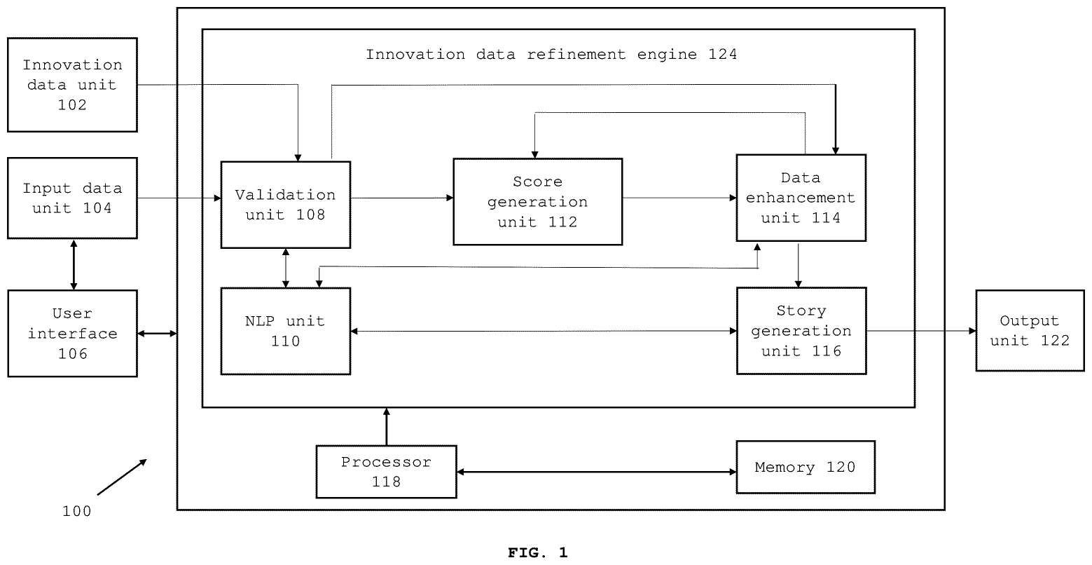

FIG. 1 is a block diagram of a system 100 for iterative refinement of innovation data using quality score, in accordance with various embodiments of the present invention. The system 100 is a generative artificial intelligence-based system. The system 100 may be implemented using a voice assistant to enhance conversational abilities. The system 100 also accepts feedback from users in a structured and improvised manner.

In an embodiment of the present invention, the system 100 comprises an innovation data unit 102, an input data unit 104, a user interface 106, an innovation data refinement engine 124 and an output unit 122. The innovation data refinement engine 124 comprises a validation unit 108, a score generation unit 112, a data enhancement unit 114, story generation unit 116 and a Natural Language Processing (NLP) unit 110. In an embodiment of the present invention, the units of the system 100 operate in conjunction with each other and are operated via a processor 118 specifically programmed to execute instructions stored in a memory 120 for executing respective functionalities of the units of the system 100.

In an embodiment of the present invention, the system 100 may be implemented in a cloud computing architecture in which data, applications, services, and other resources are stored and delivered through shared data centres. In an the exemplary embodiment of present invention, the functionalities of the system 100 are delivered to a user as Software as a Service (Saas) or Platform as a Service (PaaS) over a communication network.

In another embodiment of the present invention, the system 100 may be implemented as a client-server architecture. In this embodiment of the present invention, a client terminal accesses a server hosting the system 100 over a communication network. The client terminals may include but are not limited to a smart phone, a computer, a tablet, microcomputer or any other wired or wireless terminal. The server may be a centralized or a decentralized server. The server may be located on a public/private cloud or locally on a particular premise.

In an embodiment of the present invention, the innovation data unit 102 is connected to a backend database of an enterprise. The innovation data unit 102 fetches and stores innovation data from the backend database. The innovation data includes data related to innovation process of a project development lifecycle. In an exemplary embodiment of the present invention, the innovation data relates to enterprise knowledge in the form of chat history and one or more ideas entered by employees of an enterprise. In another exemplary embodiment of the present invention, the innovation data includes data relating to previous/historical projects and engagements related data and data related to past and ongoing innovation initiatives. In yet another exemplary embodiment of the present invention, the innovation data includes project details, outcomes, challenges, and other relevant information.

In an embodiment of the present invention, the input data unit 104 is configured to receive input data from one or more users. In an exemplary embodiment of the present invention, the input data may be in form of complete sentences to ensure a coherent response. In another exemplary embodiment of the present invention, the input data may be in form of open-ended queries. The input data unit 104 receives the input data from one or more users via a Single Sign On (SSO) authentication-based login. In an exemplary embodiment of the present invention, the input data is received by the input data unit 104 in the form of chat messages, an opportunity type, description of business problems, current scenarios and one or more issues faced by end-users/IT teams/clients. In another exemplary embodiment of the present invention, the input data unit 104 receives the input data in terms of forecasted values based on one or more benefits that are foreseen upon implementation of an idea.

In another embodiment of the present invention, the input data unit 104 is configured to receive input data in the form of a pre-defined workflow. In an exemplary embodiment of the present invention, the input data unit 104 receives the input data in the form of data related to hackathons. In another exemplary embodiment of the present invention, the input data unit 104 receives the input data in the form of crowdsourced ideas where multiple users may share ideas. In yet another embodiment of the present invention, the input data unit 104 receives the input data in the form of one or more idea descriptions and problem statements.

In an embodiment of the present invention, the user interface 106 is configured to render previous ideas entered by one or more users against an identified opportunity. The user interface 106 tags the input data and the innovation data to the ideas in a reusable asset (not shown) using Knowhub®. The chat after user interface 106 erases history a predetermined interval of time.

In an embodiment of the present invention, the validation unit 108 is configured to fetch the input data and the innovation data from the input data unit 104 and the innovation data unit 102. The validation unit 108 validates the input data and the innovation data based on one or more pre-defined grammar rules employing an NLP model stored in the NLP unit 110 to generate validated data. In an embodiment of the present invention, the validation unit 108 is configured to implement Azure AI® content safety technique, which is as an Artificial Intelligence (AI) technique to detect harmful user-generated and AI-generated content in applications and services. The validation unit 108 may access the tagged input data and innovation data in the reusable asset for carrying out the validation. The validation unit 108 blocks one or more changes to a structure of the input data and the innovation data and also blocks unsafe Hypertext Markup Language (HTML) or JavaScript content in the input data and the innovation data.

In another embodiment of the present invention, the validation unit 108 prohibits jailbreak of Large Language Models (LLMs). The validation unit 108 also prohibits malicious code, Uniform Resource Locator (URL), link or website cyber security threat in the input data and the innovation data. In yet another embodiment of the present invention, the validation unit 108 blocks the input data and the innovation data that attempt to access or modify system data or configuration. In another embodiment of the present invention, the validation unit 108 blocks the input data and the innovation data that attempt to modify the given system prompt and also blocks other harmful data in the input data and innovation data. The validation unit 108 also blocks the input data and the innovation data which are unrelated to technology and language standards.

In an embodiment of the present invention, the score generation unit 112 is configured to fetch the validated data from the validation unit 108 and determines a quality score for the validated data based on a weighted score of one or more predefined parameters. In an embodiment of the present invention, the pre-defined parameters represent one or more attributes for assessing potential and impact of innovation. The one or more predefined parameters include one or more associated first nested parameters. The first nested parameters represent one or more specific characteristics associated with the pre-defined parameters. The one or more first nested parameters include one or more associated second nested parameters. The second nested parameters represent one or more specific categories associated with the first nested parameter.

In an exemplary embodiment of the present invention, the weighted score of the one or more predefined parameters is assigned via an AI agent based on pre-defined criteria employing chain of thoughts and tree of thoughts prompting techniques. The quality score is on a scale of 1-10, in accordance with an exemplary embodiment of the present invention. In an embodiment of the present invention, the quality score is determined by dividing the total weighted score of the predefined parameters by a total number of second nested parameter and first nested parameters for which no second nested parameters exist, as illustrated herein below by way of an example as shown in the table below:

TABLE 1

| S. | Predefined | First nested | Second nested |
|---|---|---|---|
| No. | parameters | parameters | parameters |
| 1. | Degree of | Novelty of the | |
| | Innovativeness = | idea (Closest | |
| | 8.00 | score * | |
| | | weightage %) = | |
| | | 3.00 | |
| | | Uniqueness of | Innovative |
| | | the idea = 5.00 | features = 4.00 |
| | | | Advanced |
| | | | technology = |
| | | | 1.00 |
| 2. | Trends in the | Technological | Adaption |
| | industry = 5.00 | trends = 3.00 | pattern = 2.00 |
| | | | Market |
| | | | disruption = |
| | | | 1.00 |
| | | Competitive | Market trends |
| | | Landscape = 1.00 | dynamics = 1.00 |
| | | Consumer demand | Latent demand |
| | | 1.00 | 1.00 |
| 3. | Desirability = | User Need = 7.00 | Functional |
| | 14.00 | | needs = 1.00 |
| | | | Usability |
| | | | needs = 6.00 |
| | | Market demand = | Total market |
| | | 1.00 | demand = 1.00 |
| | | User experience = | Usability and |
| | | 6.00 | accessibility = |
| | | | 6.00 |
| 4. | Viability = | Alignment with | Strategic fit = |
| | 10.00 | business | 4.00 |
| | | strategy = 4.00 | |
| | | Market | Total revenue |
| | | Potential = 1.00 | Potential = 1.00 |
| | | Scalability = | System |
| | | 5.00 | scalability = |
| | | | 5.00 |
| 5. | Feasibility = | Technical | Implementation |
| | 21.00 | Feasibility = | Viability = 7.00 |
| | | 7.00 | |
| | | Financial | Cost-Benefit |
| | | Feasibility = | Analysis = 7.00 |
| | | 7.00 | |
| | | Time | Project |
| | | Feasibility = | Timeline |
| | | 7.00 | Assessment = |
| | | | 7.00 |
| 6. | Quality Score = | | |
| | (total score of | | |
| | the | | |
| | parameters)/ | | |
| | (total number of | | |
| | second nested | | |
| | parameter and | | |
| | first nested | | |
| | parameters for | | |
| | which no second | | |
| | nested | | |
| | parameters | | |
| | exist) = | | |
| | (58/17) = | | |
| | 3.41 | | |

In the above example, total number of second nested parameters are 16 and for the first nested parameter (novelty of the idea (closest score*weightage %)) there is no second nested parameter. The total score of the parameters is 8+5+14+10+21=58. Therefore, the quality score is =(58/(16+1))=3.41.

In an embodiment of the present invention, the quality score is assigned to the validated data based on an evaluation matrix obtained based on values obtained for the predefined parameters, the first nested parameters and the second nested parameters. In an exemplary embodiment of the present invention, the evaluation matrix is obtained based on a rubric based framework, which ensures consistent and objective evaluation. In an embodiment of the present invention, the score generation unit 112 is configured to provide an option to the user to modify the input data based on the generated quality score via the user interface 106.

In an embodiment of the present invention, the data enhancement unit 114 is configured to fetch the validated data from the validation unit 108 and generate a prompt data employing the NLP model stored in the NLP unit 110. The data enhancement unit 116 enhances the prompt data employing one or more enhancement rules based on the quality score fetched from the score generation unit 112 to generate an enhanced prompt data. In an embodiment of the present invention, the enhancement rules are generated basis a determination of a context of the validated data in terms of one or more features including, but are not limited to, problem-statement, title, idea description, and enhancing the prompt data by reconstructing the prompt data by classifying the validated data in terms of one or more enhancement parameters including, but are not limited to, persona, task, input elements, generative, directive along with the context.

In an embodiment of the present invention, the data enhancement unit 114 is configured to provide an option to the user to modify the input data based on the prompt data via the user interface 106 to generate the enhanced prompt data. The data enhancement unit 114 provides one or more additional inputs to enhance the validated data based on the enhanced prompt data using the NLP model stored in the NLP unit 110.

In an embodiment of the present invention, the data enhancement unit 114 summarises the enhanced prompt data via the NLP model stored in the NLP unit 110 to render the enhanced prompt data understandable and also to improve quality of the enhanced prompt data by refining language and structure of the enhanced prompt data rendering it easier for reviewers to quickly grasp core concepts and potential of each idea. In an exemplary embodiment of the present invention, the data enhancement unit 114 i summarises the prompt data in form of check boxes using the NLP model.

In another embodiment of the present invention, the score generation unit 112 is configured to fetch the enhanced prompt data from the data enhancement unit 114 and assign an enhanced quality score to the enhanced prompt data and transmit the enhanced prompt data with the assigned enhanced quality score to the data enhancement unit 114. The data enhancement unit 114 summarises the enhanced prompt data in the form of check boxes. In an embodiment of the present invention, the data enhancement unit 114 provides an option to the user to modify the enhanced prompt data based on the enhanced quality score to generate a modified prompt data.

In an embodiment of the present invention, the story generation unit 116 is configured to fetch the modified prompt data from the data enhancement unit 114. The story generation unit 116 refines the modified prompt data by narrowing down the enhanced prompt data to viable solution based on feasibility and impact analysis based on existing solutions to generate user story data. The story generation unit 116 generates features representative of refined innovation data based on the modified prompt employing LLMs. In an exemplary embodiment of the present invention, the features are a list of solutions in terms of a user story data or epic data. In an embodiment of the present invention, the 122 is configured to fetch the features from the story generation unit 116 and generate a code for deployment based on the features. In an exemplary embodiment of the present invention, the code is deployed using GitHub Copilot®tool.

In another embodiment of the present invention, a plurality of configuration parameters of the NLP model of the NLP unit 110 may be varied via the user interface 106. The configuration parameters are static values. In an exemplary embodiment of the present invention, the plurality of configuration parameters includes a first parameter relating to tokens. In an example, the number of tokens is set to a value of 16,000. In another exemplary embodiment of the present invention, the plurality of configuration parameters includes a second parameter relating to a temperature parameter of the NLP model that relates to controlling randomness and creativity of the generated text that is used to adjust probabilities of predicted words.

In an example, the temperature value may be set to a value of 1.0 that provides more details of particular ideas. In another exemplary embodiment of the present invention, the plurality of configuration parameters includes a third parameter relating to a frequency penalty parameter that represents permutation and combinations with respect to a particular trend. In an example, the frequency penalty parameters may be set to a value of 0.95 that provides the best permutations and combinations in terms of the trend.

In an embodiment of the present invention, the system 100 is based on .Net utility that facilitates seamless integration of various elements, ensuring smooth operation thereby managing flow of data and responses within the system 100. In another embodiment of the present invention, the system 100 is based on chain of thoughts methodology for evaluating ideas. In yet another embodiment of the present invention, the NLP model may be Open AI® based model. In another embodiment of the present invention, the NLP model may be an Azure Open AI® based model.

Advantageously, the system 100 maximizes utilization of pre-existing innovation data and one or more ideas and generates innovative ideas based user stories for decision-making in ongoing innovation projects. The system 100 provides suggestions to augment innovative ideas that helps to promote grassroots innovation for enhancing engagement, automating processes, and driving customer satisfaction. The system 100 accelerates innovation by reducing lead time, thereby fast-tracking grassroots innovation by transforming innovation in project development life cycles at an enterprise scale. The system 100 also generates a diverse array of innovative solutions based on advanced data processing and machine learning techniques thereby enhancing quality and variety of the output, thereby improving processing capability of the system 100 leading to improved computing efficiency.

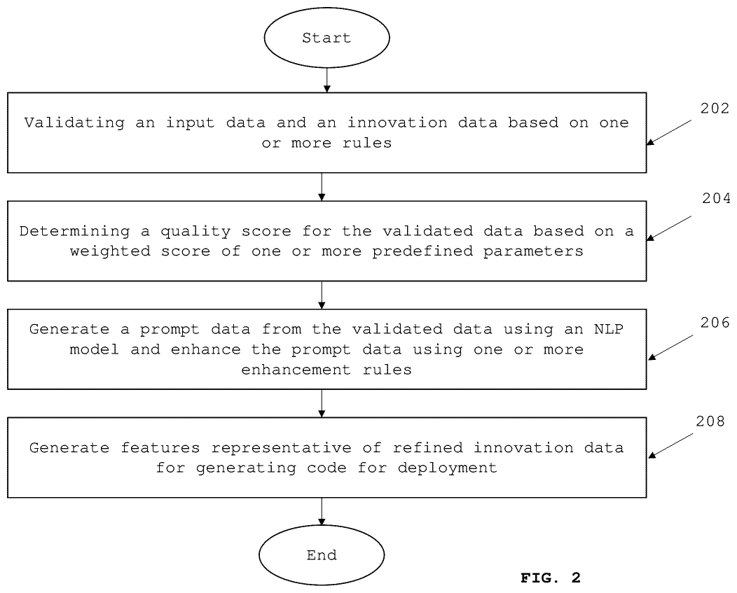

FIG. 2 illustrates a method for iterative refinement of innovation data using quality score, in accordance with an embodiment of the present invention.

At step 202, an input data and an innovation data is validated based on one or more rules. In an embodiment of the present invention, the innovation data is fetched from a backend database. The innovation data includes data related to innovation process of a project development lifecycle. In an exemplary embodiment of the present invention, the innovation data relates to enterprise knowledge in the form of chat history and one or more ideas entered by employees of an enterprise. In another exemplary embodiment of the present invention, the innovation data includes data relating to previous/historical projects and engagements related data and data related to past and ongoing innovation initiatives. In yet another exemplary embodiment of the present invention, the innovation data includes project details, outcomes, challenges, and other relevant information.

In an exemplary embodiment of the present invention, the input data may be in form of complete sentences to ensure a coherent response. In another exemplary embodiment of the present invention, the input data may be in form of open-ended queries. The input data is received from one or more users via a Single Sign On (SSO) authentication-based login. In an exemplary embodiment of the present invention, the input data is received in the form of chat messages, an opportunity type, description of business problems, current scenarios and one or more issues faced by end-users/IT teams/clients. In another exemplary embodiment of the present invention, the input data is received in terms of forecasted values based on one or more benefits that are foreseen upon implementation of an idea.

In an embodiment of the present invention, the input data is received in the form of a pre-defined workflow. In another embodiment of the present invention, the input data is received in the form of data related to hackathons. In yet another embodiment of the present invention, the input data is in the form of crowdsourced ideas where multiple users may share ideas. In another embodiment of the present invention, the input data is in the form of one or more idea descriptions and problem statements.

In an embodiment of the present invention, previous ideas entered by one or more users are rendered against an identified opportunity. The input data and the innovation data are tagged to the ideas in a reusable asset (not shown) using Knowhub®. The chat history is erased after a predetermined interval of time.

At step 204, a quality score is determined for the validated data based on a weighted score of one or more predefined parameters. In an embodiment of the present invention, the input data and the innovation data are validated based on one or more pre-defined grammar rules employing the NLP model to generate validated data. In an embodiment of the present invention, Azure AI® content safety technique is implemented, which is AI a technique to detect harmful user-generated and AI-generated content in applications and services. The tagged input data and innovation data may be accessed in the reusable asset for carrying out the validation. In an exemplary embodiment of the present invention, one or more changes to a structure of the input data and unsafe Hypertext Markup Language (HTML) or JavaScript content in the input data and the innovation data are blocked.

In another exemplary embodiment of the present invention, jailbreak of LLMs is prohibited along with malicious code, Uniform Resource Locator (URL), link or website cyber security threat in the input data and the innovation data. In yet another exemplary embodiment of the present invention, the input data and the innovation data that attempt to access or modify system data or configuration are blocked. In another exemplary embodiment of the present invention, input data and the innovation data that attempt to modify the given system prompt are also blocked along with other harmful data. In another exemplary embodiment of the present invention, the input data and the innovation data which are unrelated to technology and language standards are also blocked.

In an embodiment of the present invention, the quality score is determined for the validated data based on a weighted score of one or more predefined parameters. In an embodiment of the invention, present the pre-defined parameters represent one or more attributes for assessing potential and impact of innovation. The one or more predefined parameters include one or more associated first nested parameters. The first nested parameters represent one or more specific characteristics associated with the pre-defined parameters. The one or more first nested parameters include one or more associated second nested parameters The second nested parameters represent one or more specific categories associated with the first nested parameter. In an exemplary embodiment of the present invention, the weighted score of the one or more predefined parameters is assigned via an AI agent based on pre-defined criteria employing chain of thoughts and tree of thoughts prompting techniques. The quality score is on a scale of 1-10, in accordance with an exemplary embodiment of the present invention.

In an embodiment of the present invention, the quality score is determined by dividing the total weighted score of the predefined parameters by a total number of second nested parameter and first nested parameters for which no second nested parameters exist. Examples of predefined parameters, first nested parameters and second nested parameters are provided in table 1 above.

In an embodiment of the present invention, the quality score is assigned to the validated data based on an evaluation matrix obtained based on values of the predefined parameters, first nested parameters and the second nested parameters. In an exemplary embodiment of the present invention, the quality score is assigned to the validated data by the score based on a rubric based framework, which ensures consistent and objective evaluation. In an embodiment of the present invention, an option is provided to the user to modify the input data based on the generated quality score.

At step 206, a prompt data is generated from the validated data using the NLP model and the prompt data is enhanced using one or more enhancement rules. In an embodiment of the present invention, a prompt data is generated employing the NLP model. The prompt data is enhanced employing one or more enhancement rules based on the quality score to generate an enhanced prompt data.

In an embodiment of the present invention, the enhancement rules are obtained based on a determination of a context of the validated data in terms of one or more features including, but are not limited to, problem-statement, title, idea description, and enhancing the prompt data by reconstructing the prompt data by classifying the validated data in terms of one or more enhancement parameters including, but not limited to, persona, task, input elements, generative, directive along with the context. In an embodiment of the present invention, an option is provided to the user to modify the input data based on the prompt data to generate the enhanced prompt data. One or more additional inputs are provided to enhance the validated data based on the enhanced prompt data using the NLP model.

In another embodiment of the present invention, an enhanced quality score is assigned to the enhanced prompt data. The enhanced prompt data is summarised in the form of check boxes. In an embodiment of the present invention, an option is provided to the user to modify the enhanced prompt data based on the enhanced quality score to generate a modified prompt data.

In an embodiment of the present invention, the modified prompt data is refined by narrowing down the enhanced prompt data to viable solutions based on feasibility and impact analysis based on existing solutions to generate user story data. Features representative of refined innovation are generated data based on the modified prompt employing LLMs. In an exemplary embodiment of the present invention, the features are a list of solutions in terms of a user story data or epic data. In an embodiment of the present invention, a code is generated for deployment based on the features. In an exemplary embodiment of the present invention, the code is deployed using GitHub Copilot®tool.

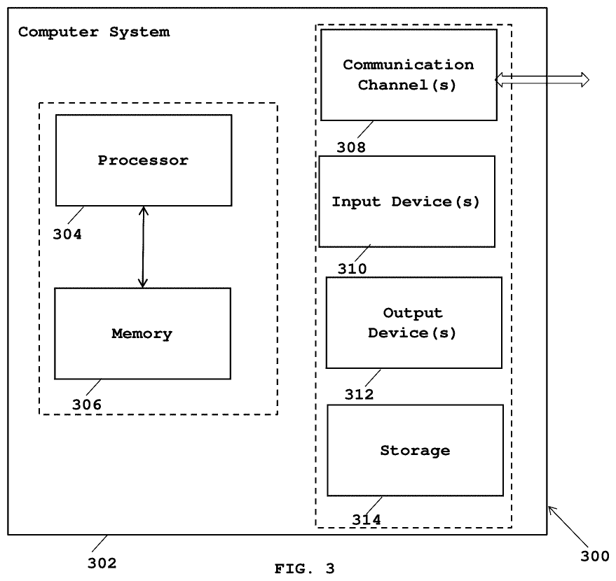

FIG. 3 illustrates an exemplary computer system in which various embodiments of the present invention may be implemented. The computer system 302 comprises a processor 304 and a memory 306. The processor 304 executes program instructions and is a real processor. The computer system 302 is not intended to suggest any limitation as to scope of use or functionality of described embodiments. For example, the computer system 302 may include, but not limited to, a programmed microprocessor, a micro-controller, a peripheral integrated circuit element, and other devices or arrangements of devices that are capable of implementing the steps that constitute the method of the present invention. In an embodiment of the present invention, the memory 306 may store software for implementing an embodiment of the present invention. The computer system 302 may have additional components.

For example, the computer system 302 includes one or more communication channels 308, one or more input devices 310, one or more output devices 312, and storage 314. An interconnection mechanism (not as shown) such a bus, controller, or network, interconnects the components of the computer system 302. In an embodiment of the present invention, operating system software (not shown) provides an operating environment for various software executing in the computer system 302, and manages different functionalities of the components of the computer system 302.

The communication channel(s) 308 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, Bluetooth or other transmission media.

The input device(s) 310 may include, but not limited to, a keyboard, mouse, pen, joystick, trackball, a voice device, a scanning device, touch screen or any another device that is capable of providing input to the computer system 302. In an embodiment of the present invention, the input device(s) 310 may be a sound card or similar device that accepts audio input in analog or digital form. The output device(s) 312 may include, but not limited to, a user interface on CRT or LCD, printer, speaker, CD/DVD writer, or any other device that provides output from the computer system 302.

The storage 314 may include, but not limited to, magnetic disks, magnetic tapes, CD-ROMS, CD-RWs, DVDs, flash drives or any other medium which can be used to store information and can be accessed by the computer system 302. In an embodiment of the present invention, the storage 314 contains program instructions for implementing the described embodiments.

The present invention may suitably be embodied as a computer program product for use with the computer system 302. The method described herein is typically implemented as a computer program product, comprising a set of program instructions which is executed by the computer system 302 or any other similar device. The set of program instructions may be a series of computer readable codes stored on a tangible medium, such as a computer readable storage medium (storage 314), for example, diskette, CD-ROM, ROM, flash drives or hard disk, or transmittable to the computer system 302, via a modem or other interface device, over either a tangible medium, including but not limited to optical or analogue communications channel(s) 308. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the internet or a mobile telephone network. The series of computer readable instructions may embody all or part of the functionality previously described herein.

The present invention may be implemented in numerous ways including as a system, a method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention.

We claim:

1. A system for iterative refinement of innovation data, the system comprising:
a memory storing program instructions;
a processor executing program instructions stored in the memory and configured to execute an innovation data refinement engine to:
fetch input data and innovation data to validate the input data and the innovation data to generate a validated data, wherein the innovation data represents data related to an innovation process of a project development lifecycle;
determine a quality score for the validated data based on a weighted score of one or more predefined parameters;
generate a prompt data from the validated data using employing an NLP model;
enhance the prompt data based on the quality score employing enhancement rules to generate an enhanced prompt data;
assign an enhanced quality score to the enhanced prompt data to generate a modified prompt data; and
generate features representative of refined innovation data for generating a code for deployment based on the modified prompt data.

2. The system as claimed in claim 1, wherein the innovation data refinement engine fetches the input data from an input data unit, the input data includes forecasted values based on one or more benefits foreseen upon implementation of an idea, pre-defined workflow, idea descriptions and problem statements, chat messages, an opportunity type, description of business problems, current scenarios, one or more issues faced by end-users, IT teams, clients, data related to hackathons, and crowdsourced ideas where multiple users share ideas.

3. The system as claimed in claim 1, wherein the innovation data refinement engine fetches the innovation data from an innovation data unit, the innovation data includes data relating to historical projects and engagements related data, data related to past and ongoing innovation initiatives, and project details, outcomes, challenges, and other relevant information.

4. The system as claimed in claim 1, wherein the innovation data refinement engine comprises a validation unit configured to validate the input data and the innovation data based on one or more pre-defined grammar rules employing the NLP model in an NLP unit of the innovation data refinement engine.

5. The system as claimed in claim 4, wherein the system comprises a user interface 106 for rendering previous ideas entered by one or more users against an identified opportunity, and wherein the validation unit accesses the tagged input data and innovation data in the reusable asset for carrying out the validation.

6. The system as claimed in claim 4, wherein the validation unit is configured to validate the input data and innovation based on pre-defined grammar rules by employing the NLP model stored in an NLP unit of the innovation data refinement engine, and wherein the validation unit is configured to:
block one or more changes to a structure of the input data and innovation data;
Language (HTML) or block unsafe Hypertext Markup JavaScript content in the input data and the innovation data;
block the input data and the innovation data that attempt to access or modify system data or configuration;
block the input data and the innovation data that attempt to modify the given system prompt and other harmful data in the input data and innovation data;
block the input data and the innovation data which are unrelated to technology and language standards;
prohibit jailbreak of large language models; and
prohibit malicious code, uniform resource locator, link or website cyber security threat in the input data and the innovation data.

7. The system as claimed in claim 1, wherein the innovation data refinement engine comprises a score generation unit configured to determine the quality score by dividing the total weighted score of the predefined parameters by a total number of second nested parameter and first nested parameters for which no second nested parameters exist.

8. The system as claimed in claim 7, wherein the one or more predefined parameters represent one or more attributes for assessing potential and impact of innovation, and wherein the predefined parameters are associated with one or more first nested parameters, the first nested parameters represent one or more specific characteristics associated with the pre-defined parameters, and wherein the one or more first nested parameters are associated with one or more second nested parameters, the second nested parameters represent one or more specific categories associated with the first nested parameter.

9. The system as claimed in claim 7, wherein the score generation unit assigns the quality score to the validated data based on an evaluation matrix, wherein the evaluation matrix is obtained based on values obtained for the predefined parameters, the first nested parameters and the second nested parameters.

10. The system as claimed in claim 1, wherein the innovation data refinement engine comprises a data enhancement unit configured to:
generate the prompt data associated with the validation data employing the NLP model stored in an NLP unit of the innovation data refinement engine;
generate the enhanced prompt data based on the quality score employing the enhancement rules to generate the enhanced prompt data, wherein the enhancement rules are generated basis a determination of a context of the validated data in terms of one or more features including, problem-statement, title, idea description, and enhancing the prompt data by reconstructing the prompt data by classifying the validated data in terms of one or more enhancement parameters including persona, task, input elements, generative, directive along with the context; and
enhance the validated data based on the enhanced prompt data employing one or more additional inputs using the NLP model.

11. The system as claimed in claim 10, wherein the innovation data refinement engine comprises a score generation unit configured to:
assign the enhanced quality score to the enhanced prompt data received from the data enhancement unit;
transmit the enhanced prompt data with the assigned enhanced quality score to the data enhancement unit; and
enable generation of the modified prompt data based on the enhanced quality score.

12. The system as claimed in claim 11, wherein the innovation data refinement engine comprises a story generation unit configured to generate the features based on the modified prompt data employing LLMs, wherein the features represent user story data and epic data.

13. The system as claimed in claim 12, wherein the innovation data refinement engine comprises an output unit configured to generate the code for deployment based on the generated features.

14. A method for iterative refinement of innovation data, the method comprising steps of:
fetching input data and innovation data to validate the input data and the innovation data to generate a validated data, wherein the innovation data represents data related to an innovation process of a project development lifecycle;
determining a quality score for the validated data based on a weighted score of one or more predefined parameters;
generating a prompt data from the validated data employing an NLP model;
enhancing the prompt data based on the quality score employing enhancement rules to generate an enhanced prompt data;
assigning an enhanced quality score to the enhanced prompt data to generate a modified prompt data; and
generating features representative of refined innovation data for generating a code for deployment based on the modified prompt data.

15. The method as claimed in claim 14, wherein the input data includes forecasted values based on one or more benefits foreseen upon implementation of an idea, pre-defined workflow, idea descriptions and problem statements, chat messages, an opportunity type, description of business problems, current scenarios, one or more issues faced by end-users, IT teams, clients, data related to hackathons, and crowdsourced ideas where multiple users share ideas.

16. The method as claimed in claim 14, wherein the innovation data includes data relating to historical projects and engagements related data, data related to past and ongoing innovation initiatives, and project details, outcomes, challenges, and other relevant information.

17. The method as claimed in claim 14, wherein the step of validating the input data and the innovation data comprises validating the input data and innovation based on pre-defined grammar rules by employing the NLP model, and wherein the step of validating the input data and the innovation data comprises the steps of:
blocking one or more changes to a structure of the input data and innovation data;
blocking unsafe Hypertext Markup Language (HTML) or JavaScript content in the input data and the innovation data;
blocking the input data and the innovation data that attempt to access or modify system data or configuration;
blocking the input data and the innovation data that attempt to modify the given system prompt and other harmful data in the input data and the innovation data;
blocking the input data and the innovation data which are unrelated to technology and language standards;
prohibiting jailbreak of large language models; and
prohibiting malicious code, Uniform Resource Locator (URL), link or website cyber security threat in the input data and the innovation data.

18. The method as claimed in claim 14, wherein the step of determining the quality score for the validated data comprises:
determining the quality score by dividing the total weighted score of the predefined parameters by a total number of second nested parameter and first nested parameters for which no second nested parameters exist wherein the quality score is assigned to the validated data based on an evaluation matrix, the evaluation matrix is obtained based on values obtained for the predefined parameters, the first nested parameters and the second nested parameters.

19. The method as claimed in claim 18, wherein the one or more predefined parameters represent one or more attributes for assessing potential and impact of innovation, and wherein the predefined parameters are associated with one or more first nested parameters, the first nested parameters represent one or more specific characteristics associated with the pre-defined parameters, and wherein the one or more first nested parameters are associated with one or more second nested parameters, the second nested parameters represent one or more specific categories associated with the first nested parameter.

20. The method as claimed in claim 14, wherein the step of enhancing the prompt data to generate the enhanced prompt data comprises the steps of:
generating the enhanced prompt data employing the enhancement rules based on the quality score, wherein the enhancement rules are generated basis a determination of a context of the validated data in terms of one or more features including, problem-statement, title, idea description, and enhancing the prompt data by reconstructing the prompt data by classifying the validated data in terms of one or more enhancement parameters including persona, task, input elements, generative, directive along with the context; and
enhancing the validated data based on the enhanced prompt data employing one or more additional inputs using the NLP model.

21. A computer program product comprising:
a non-transitory computer-readable e medium having computer-readable program code stored thereon, the computer-readable program code comprising instructions that, when executed by a processor, cause the processor to:
fetch input data and innovation data to validate the input data and the innovation data to generate a validated data, wherein the innovation data represents data related to an innovation process of project development lifecycle;
determine a quality score for the validated data based on a weighted score of one or more predefined parameters;
generate a prompt data from the validated data using employing an NLP model;
enhance the prompt data based on the quality score employing enhancement rules to generate an enhanced prompt data;
assign an enhanced quality score to the enhanced prompt data to generate a modified prompt data; and
generate features representative of refined innovation data for generating a code for deployment based on the modified prompt data.
